(19) United States
(12) Patent Application Publication
(10) Pub. No.: US 2025/0121337 A1
(43) Pub. Date: Apr. 17, 2025

(54) SYSTEMS AND METHODS FOR DISTRIBUTION OF FLUIDS AND GASES

(71) Applicant: Ron L. Stevens, Aurora, CO (US)

(72) Inventor: Ron L. Stevens, Aurora, CO (US)

(21) Appl. No.: 18/913,015

(22) Filed: Oct. 11, 2024

Related U.S. Application Data
(60) Provisional application No. 63/543,559, filed on Oct. 11, 2023.

(51) Int. Cl. B01F 23/23; B01F 23/231; B01F 35/11; B01F 101/00; C02F 1/00; C02F 1/48; C02F 1/68

(52) U.S. Cl. CPC B01F 23/238; B01F 23/231; B01F 35/11; C02F 1/001; C02F 1/48; C02F 1/68; B01F 2101/305; C02F 2303/04; C02F 2303/22

(57) ABSTRACT

A system for treating water or other fluid, including through the use of a liquid restructuring chamber. The system involves the production of one or more gases for injecting into a water or other fluid supply for use in a variety of applications. Methods for producing a gaseous liquid stream is also described herein.

### CROSS-REFERENCE TO RELATED APPLICATIONS

This application claims the benefit of and priority under 35 U.S.C. § 119(e) to U.S. Provisional Patent Application No. 63/543,559 filed on Oct. 11, 2023, the entirety of which is incorporated by reference herein.

### FIELD OF THE INVENTION

This disclosure relates generally to water treatment, and in particular to systems and methods for distributing water or other liquids and gases extracted or injected into the fluids.

### DESCRIPTION OF THE RELATED ART

Current state of the art water treatment systems and methods are inefficient, or in many instances incapable with respect to providing and promoting oxygenated water, restructured water, gaseous or gas-entrained fluid streams, micro-or nano-bubble infused water and/or enhanced fluid sources. Most fluid pumps, restructuring devices, oxygenators and similar equipment suffer from significant drawbacks, which hamper their efficiency and impair their practical uses.

One known method for producing a gas-infused liquid is to electrolyze a liquid between two electrodes, in which the microbubbles are formed at the surface of one of the electrodes by a gas released in the electrolysis reaction. Electrolysis through prior art systems, however, is too costly to produce microbubbles on a large scale. Electrolysis processes also suffer from integration problems in that currently available equipment cannot be utilized in conjunction with most liquid dispensing fittings because of the physical size and configuration of the necessary components. Furthermore, such systems are typically large and require electrical enclosures to house the necessary components that are simply not suitable for most residential and commercial settings.

One such prior art method if disclosed in U.S. Pat. No. 4,556,523 to Lecoffre et al. Lecoffre discloses a microbubble injector comprising a deflector wall, which radially deflects a flow of water exiting under pressure from an injector hole and saturated with dissolved air, thus producing cavitation at the edges of the injector hole and generating microbubbles of air downstream of the injector hole.

Similarly, U.S. Pat. No. 6,293,529 to Chang et al. (“Chang”) discloses a bubble generating apparatus including a hollow shell having a plurality of bottom inlets and a side outlet, a screw rod longitudinally mounted in the shell, and a baffle threaded onto one end of the screw rod and suspended inside the shell above the bottom inlets, the baffle having a plurality of smoothly arched bottom notches for baffling intake flows of high-pressure liquid to produce bubbles.

The inventions of Lecoffre and Chang suffer from several disadvantages, however, and could not be used practically or efficiently with typical liquid dispensing fittings, such as hydrotherapy jets, shower heads, and liquid nozzles.

U.S. Patent Application Publication No. 2007/0108640 to Takahashi et al. (“Takahashi”) discloses a microbubble-generating device which incorporates small orifices or screens through which the pressurized liquid and gas must travel. Such features are undesirable because debris and contaminants present in the liquid may clog the orifices/screens, so that at least one of (1) expensive pre-filtering of the liquid prior to reaching the small orifices/screens and (2) repeated and continual cleaning of the orifices/screens would be required to maintain the device in an operational state. Extensive maintenance of this type would place an unnecessary burden on the end user and thus is not practical. The clogging of the small orifices/screens may also be detrimental to a system employing the microbubble-generating device, because the blockage could cause excessive back pressure, resulting in premature wear on system components.

These and other problems are apparent to those of ordinary skill in the art and remain unsolved.

### SUMMARY

Thus, there is a long-felt need for a system of providing gaseous fluid in a wide variety of applications, including but not limited to agriculture, health and wellness, hydrotherapy, hot tubs, plunge pools, swimming pools, traditional showers, steam showers, liquid nozzles, bathtubs, spas (and associated diffusers), and faucets. It is further advantageous for the system components to be compact, easy to configure, access and adjust, and if necessary remove and maintain periodically. In this regard, the present invention provides several modular components that may be installed, commissioned, added, removed, cleaned or otherwise maintained and reattached to the system in varying embodiments described in detail herein.

It would also be beneficial if the system did not require additional components, or components that are bulky, require tooling or reconfiguration of nozzles, diffusers, faucets, heads, basins, tubs, surrounding surfaces, flooring, etc., and that otherwise does not detract from (1) the ability to install and operate the system in a variety of confined spaces (industrial, commercial and residential), or (2) the appearance, use and enjoyment of the desired output, including related fixtures and their aesthetic or ornamental appeal. Furthermore, there is a long-felt need for a system that provides treatment of fluids from different fluid sources, such as domestic water supply, recirculated water, well or ground water, water storage and other fluid sources. It is with these objectives that the present invention is contemplated.

The present disclosure comprises a system and method for forming or otherwise generating a gaseous fluid, whereby one or more gases are introduced and entrained in a fluid stream. In embodiments, excess gas(es) may be extracted from the system for use in subsequent fluid processing or for other purposes.

The present disclosure may further comprise one or more liquid restructuring chambers. The chamber(s) preferably comprise a plurality of plates configured to receive an electrical current. In some embodiments the plates may be comprised of titanium. In embodiments, the plates may be capable of reversed polarity. The plates are preferably arranged to maximize the production of gas released through the electrical current introduced into the plates (i.e., between adjacent electrodes) provided in the liquid restructuring chamber(s).

In embodiments, the liquid restructuring chamber(s) are preferably configured to at least temporarily store both a liquid and a gas created by a liquid restructuring process. In one aspect, the plates are periodically cleaned by the introduction of gaseous matter into the chamber(s) which abrasively “scrubs” the surfaces of the plates. In another aspect, the chamber(s) may have access permitting removal and cleaning of the plates as needed.

In embodiments, the system may comprise one or more apparatus for generating micro-or nano-bubbles independent of the liquid restructuring chamber. For example, a micro-bubble generation device may be coupled to different components of the system for the purpose of increasing the gas content of the liquid, such as by injecting micro-bubbles into the liquid stream.

In embodiments, the liquid may be provided for drinking water, for enhanced agricultural production, for hydrotherapeutic treatment(s), for storage and later distribution, or for recirculation.

It is another aspect of some embodiments of the present invention to provide a water treatment and supply system having one or several of the components described herein.

It is another aspect to provide a method of forming a gaseous liquid, or otherwise entrain a gas within a fluid stream. The system components described herein may be combined in various ways to further the method(s) described herein.

In one aspect, the invention comprises a system for producing a liquid-gas mixture, comprising: a gas supply configured to supply at least one gas; a fluid supply configured to supply at least one fluid; at least one of a water restructuring apparatus, a fluid injector apparatus and a filtration apparatus arranged in series and configured to receive the at least one fluid; a liquid restructuring chamber, which comprises a plurality of plates positioned within the chamber and an electrical source coupled to each of the plurality of plates; wherein the electrical source supplies electrical current to each of the plates; wherein the at least one gas and at least one fluid are combined within the liquid restructuring chamber to form a gaseous fluid; wherein excess of the at least one gas is permitted to exit the fluid restructuring chamber by operation of a relief valve; and wherein the gaseous fluid is supplied to at least one outlet.

In another aspect, the invention comprises a method of providing a gaseous fluid, comprising the steps of: supplying a fluid source to one or more of a water restructuring apparatus, a fluid injector apparatus and a filtration apparatus; providing the fluid source to a liquid restructuring chamber; introducing an electrical current into one or more plates located within the liquid restructuring chamber; generating at least one gas in the liquid restructuring chamber; combining the at least one gas and the fluid source within the liquid restructuring chamber; removing the excess gas from the liquid restructuring chamber; injecting a cleanser to the at fluid restructuring chamber; and distributing the combined gas and fluid source to at least one destination.

In yet another aspect, the invention comprises a method of providing a gaseous fluid, comprising the steps of: supplying a fluid source to one or more of a water restructuring apparatus, a fluid injector apparatus and a filtration apparatus; providing the fluid source to a liquid restructuring chamber; introducing an electrical current into one or more plates located within the liquid restructuring chamber; supplying a gas to the liquid restructuring chamber; combining the gas and the fluid source within the liquid restructuring chamber; removing the excess gas from the liquid restructuring chamber; injecting a cleanser to the at fluid restructuring chamber; and distributing the combined gas and fluid source to at least one destination.

These and other advantages will be apparent from the disclosure contained herein.

Unless defined otherwise, all technical and scientific terms used herein have the same meaning as is commonly understood by one of ordinary skill in the art. All patents, applications, published applications, and other publications to which reference is made herein are incorporated by reference in their entirety. In the event that there is a plurality of definitions for a term herein, the ordinary meaning of a term prevails unless otherwise stated.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

### BRIEF DESCRIPTION OF THE DRAWINGS

The accompanying drawings, which are incorporated herein and constitute a part of the specification, illustrate embodiments of the disclosure, and together with the Detailed Description serve to explain the principles of these embodiments. In certain instances, details that are not necessary for an understanding of the disclosure or that render other details difficult to perceive may have been omitted. It should be understood, of course, that the present disclosure is not necessarily limited to the particular embodiments illustrated herein, and various combinations and sub-combinations of elements depicted in the drawings are expressly contemplated and within the scope of the present invention, as reflected in the appended claims.

In the drawings:

FIG. 1 depicts a schematic diagram of a system for treating water or other fluid and components thereof according to embodiments of the present disclosure.

It should be understood that the drawings are not necessarily to scale.

### DETAILED DESCRIPTION

The present disclosure further provides a method for forming an enhanced, gaseous liquid. The gaseous liquid may be provided to one or more outlets, such as a basin, tub, spa, pool, foot bath, etc., or may be alternatively separated for providing either a fluid or a gas, or both.

The system may comprise one or more injector devices for injecting additives to the fluid. In embodiments, the fluid comprises a nutrient. In another embodiment, the fluid comprises a sanitizing agent. In yet another embodiment, the fluid comprises one or more minerals.

One component of the system may be offered in the form of a liquid restructuring chamber, which is preferably comprised of a plurality of titanium plates positioned within a fluid chamber. The plates may receive an electrical current, and in embodiments may be capable of reversed polarity. The chamber is preferably designed to at least temporarily store both a liquid and a gas created by the liquid restructuring process. In other embodiments, the plates are comprised of one or more materials selected from copper, tungsten, molybdenum, iron, steel, aluminum, chrome, titanium alloy, aluminum alloy, and/or chromium alloy.

The system may further comprise a component for generating microbubbles of at least one gas in a liquid to form a microbubble-entrained liquid. U.S. Pat. No. 11,154,825, issued on Oct. 26, 2021, is incorporated by reference herein in its entirety for the expressed purpose of supplementing the description of microbubble-generating components.

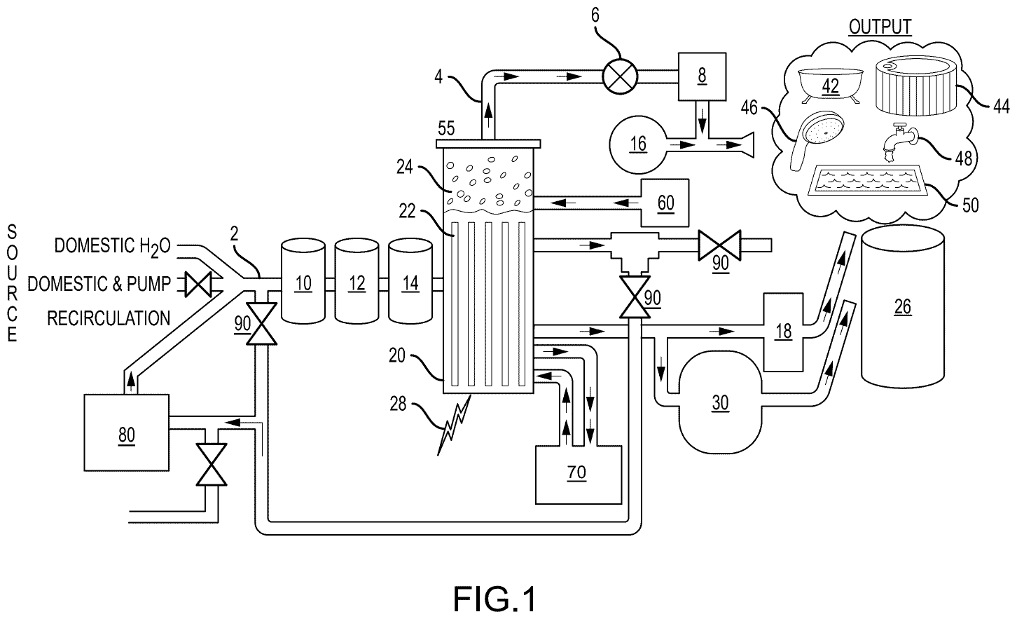

Referring now to FIG. 1, a preferred embodiment of the present disclosure for use with a fluid such as water will be described in detail. A source of water may be introduced to the system, including by way of example a domestic water source, a well or an aquifer (via a suitable pump), or from recirculation of a water source. The water source is preferably distributed via distribution lines 2 through one or more of a water restructuring apparatus 10, a fluid injector apparatus 12 and a filtration apparatus 14.

Apparatus 10, 12, 14 may be arranged in series, or alternatively may be arranged such that the sequence is variable (i.e., 10 and 14, 12 and 14, 10 and 12). In embodiments, fewer than all three apparatus 10, 12 and 14 may be employed during a specific cycle and bypass one or more of the water restructuring apparatus 10, fluid injector apparatus 12 or filtration apparatus 14. The employment of one or more apparatus 10, 12 and/or 14 may be controlled through programmable control and/or machine logic.

According to embodiments, water restructuring apparatus 10 may be provided for chemical or mineral restructuring of the water before it continues through the system, including descaling. One or more minerals may either be introduced or removed from the water during this process. Fluid injector apparatus 12 may inject one or more fluids or powders into the water stream. These fluids or powders may comprise nutrients, anti-bacterial agents, surfactants, emulsifiers, cleaning agents or other additives.

Filtration apparatus 14 may provide filtration of bacteria or related agents, for oxidation or de-oxidation, or to adjust the water ionization level prior to additional treatment. Filtration apparatus 14 may comprise one or more filter media, which is preferably comprised of a material that permits the flow of water or other fluid to pass therethrough, but also restricts the passage of bacteria, chlorine, toxins, and other microorganisms of a certain particle size. The filter material may be comprised of a cloth or equivalent material, and may be removeable from the filtration apparatus 14. In other embodiments, the material may be comprised of a composite material suitable for filtration of particle sizes specified herein. In embodiments, the filter material permits filtering of bacteria and other microorganisms larger than about 10 micron. In other embodiments, the filter is comprised of a denser material to permit filtration of microorganisms smaller than about 1 micron.

The water is then passed through liquid restructuring chamber 20, which is preferably comprised of a plurality of plates 22 positioned within the chamber 20. The plates 22 may be formed of titanium or equivalent material and configured to receive an electrical current 28 passing through the plates 28. In embodiments, the plates 28 may be further configured to receive a reversed polarity.

The chamber 20 is preferably designed to at least temporarily store both a liquid and a gas 24 created by the liquid restructuring process. The gas 24 may be captured by a separate distribution line 4 and controlled periodically by a relief valve 6. Alternatively, gaseous liquid may be supplied through distribution line 2. In certain embodiments, both liquid and gas are produced by liquid restructuring chamber 20.

Gas from the liquid restructuring chamber 20 may then by injected into a separate water supply 16 by injector 8. The gaseous liquid resulting from this injection may be supplied in a variety of different applications, including bathtubs 42, hot tubs/spas 44, handheld instruments 46, faucets 48 or pools 50. Other applications are contemplated and considered within the scope of the present disclosure, including for health/wellness, breathing apparatus, hydrotherapy, and agricultural diffusers (i.e., pivots, irrigation systems, etc.).

Returning to the fluid distribution line 2, water may exit the fluid restructuring chamber 20 and be routed either to an injector 18, or alternatively to a micro-or nano-bubble device 30. An exemplary micro-bubble device 30 is described in detail in U.S. Pat. No. 10,792,628, issued on Oct. 6, 2020, which is incorporated herein by reference. Water exiting either device 18, 30 may be supplied to any of the applications described in the preceding paragraph, or may be provided for agricultural purposes, or may be introduced into a storage vessel 26. In alternative embodiments, the water may be recirculated through the system or another system as desired.

System may further comprise at least one apparatus 70 to deliver a fluid additive. In embodiments, the fluid additive comprises at least one of a nutrient and a sanitizing agent. The additives may further comprise one or more minerals for desired effect in the particular application. In lieu of or addition to apparatus 70, additional additives for cleaning the surfaces of plates 22 may also be provided. For example, a descaling process may be initiated by periodically introducing additives to liquid restructuring chamber 20.

In embodiments, chamber 20 may have a cover 55 located at one distal end that permits access to the chamber 20 for removal, cleaning or maintenance to the internal components, including the plates 22.

The system may comprise one or more valves 90 for controlling and or redirecting fluid and/or gas flow throughout system. System may further comprise a recirculating pump 80, which preferably reintroduces restructured and/or gaseous liquid back into the system as shown in FIG. 1. In other embodiments, the recirculating pump 80 may be configured to recirculate liquid from another source or location other than liquid restructuring chamber 20.

The system may be provided as a single unit or may be combined with multiple systems. In embodiments, the system may be submersible. In other embodiments, the system may be modular and scalable to suit a particular application or desired volume of liquid, gas or other byproduct of the system. The system may be utilized for a small, single residence or may be scaled to provide an enhanced water supply to a much larger community.

As shown in FIG. 1, the system may supply gaseous fluid to at least one destination or outlet. In one embodiment, the outlet is a fitting that comprises a plurality of apertures for diverting water passing therethrough. Apertures may be arranged in a variety of patterns and/or sizes. In another embodiment, the fitting is removable from a tub, basin or fluid reservoir, and may be positionable on either an inner surface of a tub, basin or fluid reservoir, or on an outer surface of a tub, basin or fluid reservoir.

The invention illustratively disclosed herein suitably may be practiced in the absence of any element which is not specifically disclosed herein. It is apparent to those skilled in the art, however, that many changes, variations, modifications, other uses, and applications of the invention are possible, and also changes, variations, modifications, other uses, and applications which do not depart from the spirit and scope of the invention are deemed to be covered by the invention.

The term “a” or “an” entity or component, as used herein, refers to one or more of that entity or component. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

Unless otherwise indicated, all numbers expressing quantities, dimensions, conditions, and so forth used in the specification and claims are to be understood as being approximations which may be modified in all instances as required for a particular application of the novel apparatus described herein.

The foregoing discussion of the invention has been presented for purposes of illustration and description. The foregoing is not intended to limit the invention to the form or forms disclosed herein. In the foregoing Detailed Description of the Invention, for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the invention requires more features than are expressly recited. Rather, inventive aspects lie in less than all features of a single foregoing disclosed embodiment.

Moreover, though the description of the invention has included description of one or more embodiments and certain variations and modifications, other variations, combinations, and modifications are within the scope of the invention, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those described, whether or not such alternate, interchangeable, and/or equivalent structures, functions, ranges, or steps are disclosed herein, and without intending to publicly dedicate any patentable subject matter.

What is claimed is:

1. A system for producing a liquid-gas mixture, comprising:
a gas supply configured to supply at least one gas;
a fluid supply configured to supply at least one fluid;
at least one of a water restructuring apparatus, a fluid injector apparatus and a filtration apparatus arranged in series and configured to receive the at least one fluid;
a liquid restructuring chamber, which comprises:
a plurality of plates positioned within the chamber;
an electrical source for passing electrical current through each of the plurality of plates;
wherein the electrical source supplies electrical current to each of the plates;
wherein the at least one gas and at least one fluid are combined within the liquid restructuring chamber to form a gaseous fluid;
wherein excess of the at least one gas is permitted to exit the fluid restructuring chamber by operation of a relief valve; and
wherein the gaseous fluid is supplied to at least one outlet.

2. The system of claim 1, wherein the plurality of plates are further configured to receive a reverse polarity.

3. The system of claim 1, wherein the plurality of plates are formed of a material selected from the list consisting of a titanium material, a copper material, a tungsten material, a molybdenum material, an iron material, a steel material, a stainless steel material, an aluminum material, a chrome material, a titanium alloy material, an aluminum alloy material, and a chromium alloy material.

4. The system of claim 1, wherein the fluid restructuring chamber further comprises a cover at one distal end for periodic removal of one or more of the plurality of plates from the liquid restructuring chamber.

5. The system of claim 1, further comprising a pump for delivering at least one cleansing agent to the fluid restructuring chamber for cleaning the surface of the plurality of plates.

6. The system of claim 1, further comprising at least one additional gas-producing apparatus for introducing additional gases into the at least one fluid.

7. The system of claim 6, wherein the at least one additional gas-producing apparatus is a micro-bubble generator.

8. The system of claim 6, wherein the at least one additional gas producing apparatus is a nano-bubble generator.

9. The system of claim 1 further comprising at least one device for injecting additives to the at least one fluid.

10. The system of claim 10, wherein the additives comprise a nutrient, a sanitizing agent, and one or more minerals.

11. A method of providing a gaseous fluid, comprising the steps of:
supplying a fluid source to one or more of a water restructuring apparatus, a fluid injector apparatus and a filtration apparatus;
providing the fluid source to a liquid restructuring chamber;
introducing an electrical current into one or more plates located within the liquid restructuring chamber;
generating at least one gas in the liquid restructuring chamber;
combining the at least one gas and the fluid source within the liquid restructuring chamber;
removing the excess gas from the liquid restructuring chamber;
injecting a cleanser to the at fluid restructuring chamber; and
distributing the combined gas and fluid source to at least one destination.

12. The method of claim 11 further comprising the step of providing at least one additional gas to the liquid restructuring chamber.

13. The method of claim 12, wherein the at least one additional gas is formed by a micro-bubble generator.
